(19) United States
(12) Patent Application Publication
(10) Pub. No.: US 2007/0287525 A1
(43) Pub. Date: Dec. 13, 2007

(54) GAMING MACHINE

(75) Inventor: Kazunobu SATO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ARUZE CORP., Koto-ku (JP)

(21) Appl. No.: 11/753,147

(22) Filed: May 24, 2007

(30) Foreign Application Priority Data
May 29, 2006 (JP) 2006-148940

(51) Int. Cl. A63F 13/00

(52) U.S. Cl. 463/20

(57) ABSTRACT

A gaming machine includes: a display unit that variably displays a plurality of symbols in each of a plurality of variable display portions; an operation unit that allows a player to input commands; a storage unit that stores a plurality of symbol arrangement patterns, each of which defines an order of the symbols to be variably displayed; an insertion slot that allows the player to insert game medium to be bet on a game; and a processor. The processor operates to: select one from the symbol arrangement patterns based on a size of a value of the game medium bet on the game; control the display unit to variably display the symbols for a predetermined time period in each of the variable display portions in accordance with the selected symbol arrangement pattern when a start command is input through the operation unit to start the game; and pay out an award to the player in accordance with a combination of the symbols displayed stopped in the variable display portions.

### CROSS-REFERENCE TO THE RELATED APPLICATION(S)

The present application is based upon and claims priority from prior Japanese Patent Application No. 2006-148940, filed on May 29, 2006, the entire content of which are incorporated herein by reference.

### TECHNICAL FIELD

The present invention relates to a gaming machine, such as a slot machine, in which symbols aligned in a plurality of arrays are variably displayed.

### BACKGROUND

Conventionally, there is known a gaming machine, such as a slot machine, which provides a game to a player by causing a reel (a variable display device) arranged with a plurality of symbols thereon to rotate. As the variable display device installed in such kind of gaming machines, there are known a type that is provided with mechanical reels that actually rotates, and a type that is provided with a display device, such as an LCD panel and a CRT display, which displays an image of rotating reels (so-called video reels).

The gaming machine generally provides the game when a game medium (medals or coins) is inserted by the player and the player performs a start operation, as such by pressing a spin button. The gaming machine then controls the variable display device to rotate a plurality of reels, and controls the variable display device to stop the reels to display symbols to be aligned in a predetermined combination in accordance with a result of an internal lottery. The gaming machine pays out a predetermined amount of game medium to the player in accordance with the combination of the stopped symbols.

Among thus described type of gaming machines, there is a type that provides a bonus game (such as a free game), which is more advantageous to the player than a base game (normal game), to the player when a stop state of the symbols (arrangement of the stopped symbols) satisfies a predetermined state. This type of a gaming machine, as there is a probability of transitioning to the bonus game, in which a large amount of the game medium may be paid out to the player, from the base game, prevents the player from feeling bored and allows the player to keep feeling excitement and expectation while playing the game.

An example of this type of the gaming machine is disclosed in JP-A-2001-087452.

In the gaming machine, an award (game medium to be paid out) at a time of a win is changed in accordance with a size of a game value of the game medium inserted when starting a game (including a BET operation of the game medium being credited). For example, in a case in which a medal is considered as the game medium, assuming that a same winning combination is won, the award is changed in accordance with the size of the game value of the game medium inserted in such a way that when one medal is inserted (bet) in starting a game, the award is three medals, when two medals is inserted, the award is six medals, and when three medals is inserted, the award is nine medals.

However, as the player consecutively performs a series of operations, such as an insertion of the game medium (a BET operation) and an operation of a start switch while viewing the reels, it not always possible for the player to ascertain an award condition (a size of a value of the inserted (bet) game medium) of a game presently being played, and the player usually notices the award condition when the award is paid out. For this reason, the player needs to memorize value of the inserted game medium for each rounds of the game while consecutively playing a plurality of rounds of games in order to instantly ascertain an amount of the payout (the award) for each rounds of the game. This causes a feeling of a burden for the player in playing the game.

### SUMMARY

One of objects of the present invention is to provide a gaming machine that allows a player to immediately ascertain an insertion amount of a game medium (a game value of the inserted (bet) game medium) without memorizing the insertion amount during the game.

According to a first aspect of the invention, there is provided a gaming machine including: a display unit that variably displays a plurality of symbols in each of a plurality of variable display portions; an operation unit that allows a player to input commands; a storage unit that stores a plurality of symbol arrangement patterns, each of which defines an order of the symbols to be variably displayed; an insertion slot that allows the player to insert game medium to be bet on a game; and a processor. The processor operates to: select one from the symbol arrangement patterns based on a size of a value of the game medium bet on the game; control the display unit to variably display the symbols for a predetermined time period in each of the variable display portions in accordance with the selected symbol arrangement pattern when a start command is input through the operation unit to start the game; and pay out an award to the player in accordance with a combination of the symbols displayed stopped in the variable display portions.

According to a second aspect of the invention, there is provided a gaming machine including: a display unit that variably displays a plurality of symbols in each of a plurality of variable display portions; an operation unit that allows a player to input commands; a storage unit that stores a symbol arrangement pattern that defines an order of the symbols to be variably displayed; an insertion slot that allows the player to insert game medium to be bet on a game; and a processor. The processor operates to: change a specified symbol included in the symbols defined by the symbol arrangement pattern based on a size of a value of the game medium bet on the game; control the display unit to variably display the symbols for a predetermined time period in each of the variable display portions in accordance with the symbol arrangement pattern when a start command is input through the operation unit to start the game; and pay out an award to the player in accordance with a combination of the symbols displayed stopped in the variable display portions.

### BRIEF DESCRIPTION OF THE DRAWINGS

In the accompanying drawings:

FIG. 1 is a view showing an external perspective view of a slot machine as an embodiment of a gaming machine according to the invention;

FIG. 2 is a view showing a configuration of variable display portions of a main display;

FIG. 3 is a view showing positions of activated pay lines;

FIG. 4 is a block diagram schematically showing a control system of the slot machine;

FIG. 5 is a block diagram showing an example of an internal configuration of an image control circuit;

FIG. 6 is a diagram showing a symbol arrangement pattern table selected when a BET quantity is one;

FIG. 7 is a diagram showing a symbol arrangement pattern table selected when a BET quantity is two;

FIG. 8 is a diagram showing a symbol arrangement pattern table selected when a BET quantity is three;

FIG. 9 is a diagram showing a symbol arrangement pattern table selected when a BET quantity is four;

FIG. 10 is a diagram showing a symbol arrangement pattern determination table;

FIG. 11 is a diagram showing a symbol selection table;

FIG. 12 is a diagram showing a winning combination determination table;

FIG. 13 is a diagram showing a free game quantity selection table;

FIG. 14 is a diagram showing an effect table;

FIG. 15 is a main flowchart showing an example of an implementation procedure of a game in the slot machine;

FIG. 16 is a flowchart showing an example of a medal insertion process procedure in the flowchart shown in FIG. 15;

FIG. 17 is a flowchart showing an example of a selection process procedure in the flowchart shown in FIG. 15;

FIG. 18 is a flowchart showing an example of a reel control process procedure in the flowchart shown in FIG. 15; and

FIG. 19 is a flowchart showing an example of a free game process procedure in the flowchart shown in FIG. 15.

### DETAILED DESCRIPTION

Hereafter, a description will be made of a slot machine according to an embodiment of a gaming machine of the present invention, with reference to the accompanying drawings.

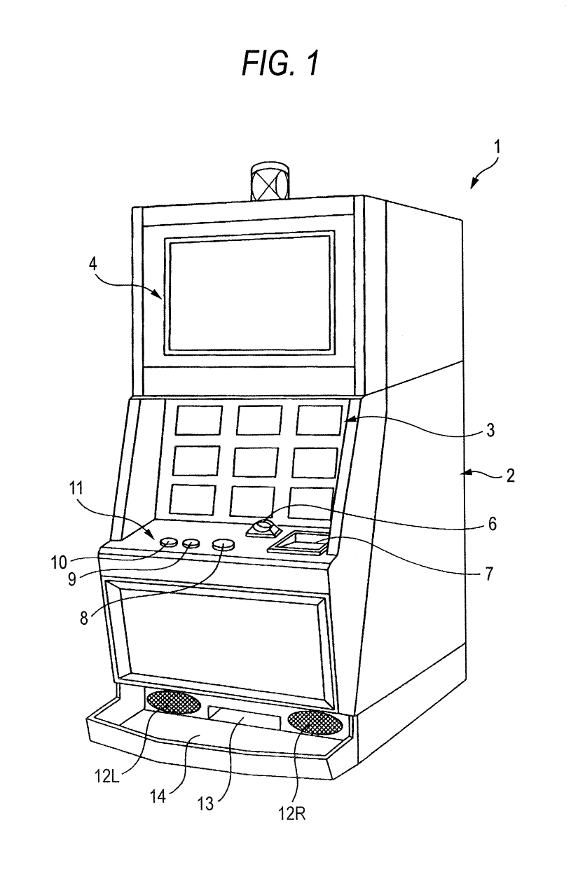

FIG. 1 is a perspective view showing an overall configuration of a slot machine 1 according to the embodiment. The slot machine 1 has a cabinet 2 and a main display 3 equipped with a liquid crystal display device disposed on a front face of the cabinet 2. The slot machine 1 also has a subsidiary display 4, likewise equipped with a liquid crystal display device, which is disposed above the main display 3.

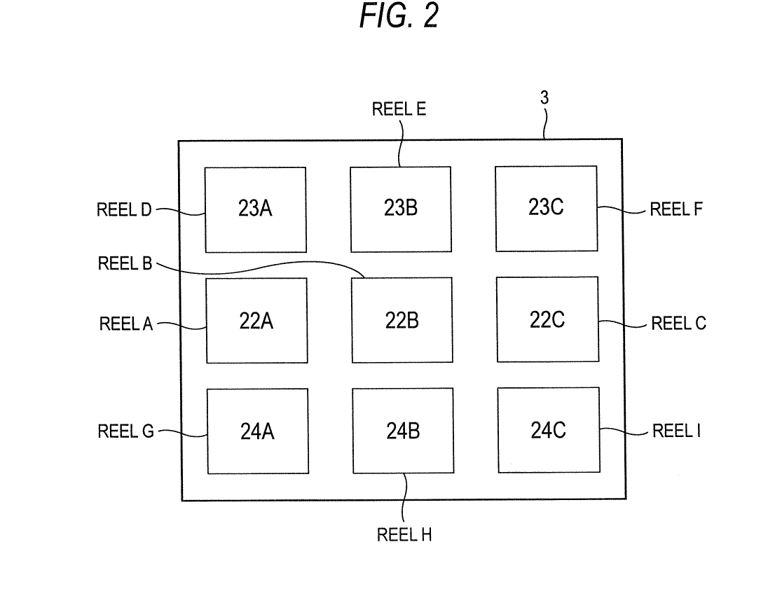

The main display 3 serves as a symbol display unit having a plurality of variable display portions, each of which displays an image of rotating reels. As shown in FIG. 2, the main display 3 displays a plurality of variable display portions (in the embodiment, a total of nine variable display portions 22A-22C, 23A-23C, and 24A-24C, arranged in three rows and in three columns) on a screen thereof. The variable display portions are visually perceived by a player as one block.

The main display 3 may be configured as a display device having a transparent touch sensitive panel that allows the player to input various operations and commands by touching the touch sensitive panel.

The main display 3 provides a base game and a bonus game (also called a free game) to the player by being controlled by a game control unit, which will be described later. In the base game, the player has a higher chance to win a large amount of game medium than in the base game. When providing the base game and the bonus game (collectively called a “game” herein), the main display 3 displays scrolling reel images (for nine reels A-I) in each of the variable display portions 22A-22C, 23A-23C and 24A-24C appearing that a plurality of symbols scroll downward for each of the nine reels A-I. In the slot machine 1, a payout amount of the game medium to be paid out is set in advance in accordance with a stopped symbol arrangement, which is an arrangement of the symbols stopped in each of the variable display portions 22A-22C, 23A-23C and 24A-24C.

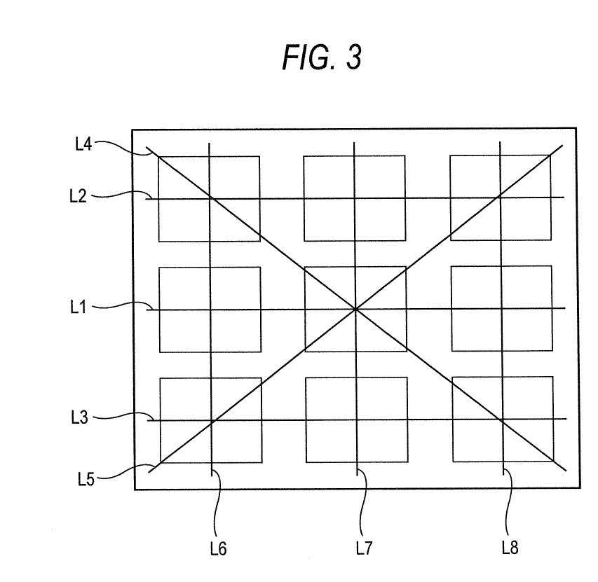

As shown in FIG. 3, the nine variable display portions 22A-22C, 23A-23C and 24A-24C being arranged in matrix, and a total of eight pay lines for determining a win are configured. The eight pay lines L1-L8 are configured by three horizontal lines L1-L3, three vertical lines L6-L8, and two diagonal lines L4 and L5 defined on the matrix of the nine variable display portions 22A-22C, 23A-23C and 24A-24C. In the embodiment, all of the eight pay lines L1-L8 are activated by a single bet.

The main display 3 may include an effect display area in which an image for dramatizing the game is displayed. For example, it is acceptable to dispose the effect display area in a peripheral area of the heretofore described variable display portions, and to display therein various kinds of effect image, background image and the like which have no relationship with the variable displays simulating the rotating reels in the variable display portions 22A-22C, 23A-23C and 24A-24C.

The effect image may be displayed on the main display 3 or on the subsidiary display 4. The effect image may be displayed on a display device that is provided separately from the main display 3 and the subsidiary display 4.

The subsidiary display 4 provided above the main display 3 displays a gaming method, a payout table indicating correspondence between a winning combination and an award, various kinds of effect and the like related to the game, information related to the game and the like. The gaming machine 1 may be configured that a simple panel on which game details are printed is disposed instead of the subsidiary display 4.

An approximately horizontal pedestal portion 11 is provided below the main display 3. A medal insertion slot 6, a bill insertion slot 7, a spin button 8, a 1 BET button 9 and a maximum BET button 10 are provided on the pedestal portion 11.

The medal insertion slot 6 is provided for the player to insert a game medium having a gaming value, such as a coin or a medal (herein, collectively called a medal), for betting on the game. The medal insertion slot 6 has a medal sensor that transmits a signal indicating an insertion of the medal. The bill insertion slot 7 is provided for the player to insert a bill, which is one of the game medium. The bill insertion slot 7 has a bill sensor 7a that transmits a signal indicating an insertion of the bill.

Apart from the heretofore described coin, the medal and the bill, a recording medium or the like which records information regarding the gaming value, such as a pre-paid card, may also be used as the game medium.

The spin button 8 has a function as a start signal output unit that outputs a signal to start of a round of the game based on a start operation by the player. The spin button 8 is provided with a spin switch that outputs a detection signal when pressed. The variable display of the symbols is started in the variable display portions 22A-22C, 23A-23C and 24A-24C.

The 1 BET button 9 is provided for betting one medal. When betting two, three or more medals, the player presses the 1 BET button 9 for a number of times according to the desired amount of medals to bet. The maximum BET button 10 is provided for performing a bet for a maximum quantity of medals which is allowed to bet on a single round of the game. The operation of these buttons being detected by a 1 BET switch and a maximum BET switch that are provided for the 1 BET button 9 and the maximum BET button 10 to output a detection signal.

A medal payout opening 13 and a medal receiving tray 14 that receives paid out medals, are provided at a bottom of the cabinet 2. A pair of speakers 12L and 12R is provided on the cabinet 2 to sandwich the medal payout opening medal 13.

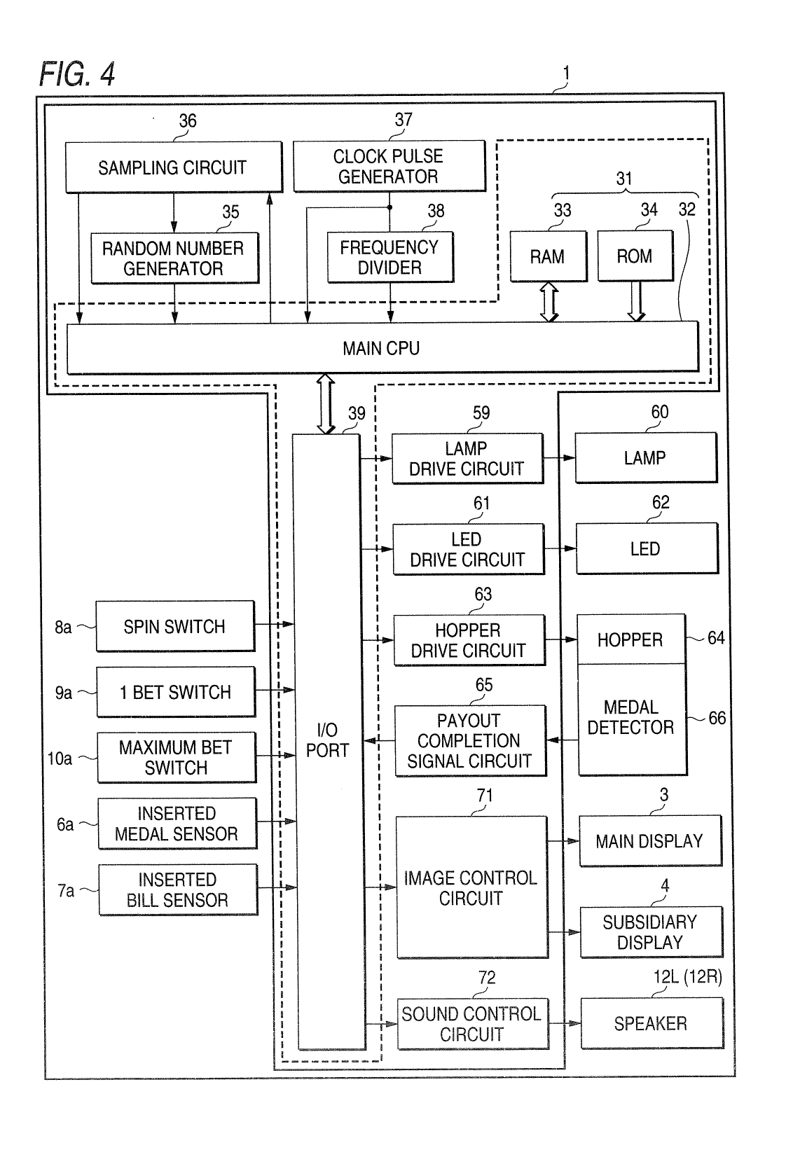

Next, a description will be given, with reference to FIG. 4, of the game control unit that controls a game operation of the slot machine 1. FIG. 4 is a block diagram that schematically shows the game control unit that controls the game operation of the slot machine 1. The game control unit is provided with a plurality of components including a microcomputer 31.

The microcomputer 31 has a main CPU (Central Processing Unit) 32 that serves as a controller, an RAM (Random Access Memory) 33 and an ROM (Read Only Memory) 34.

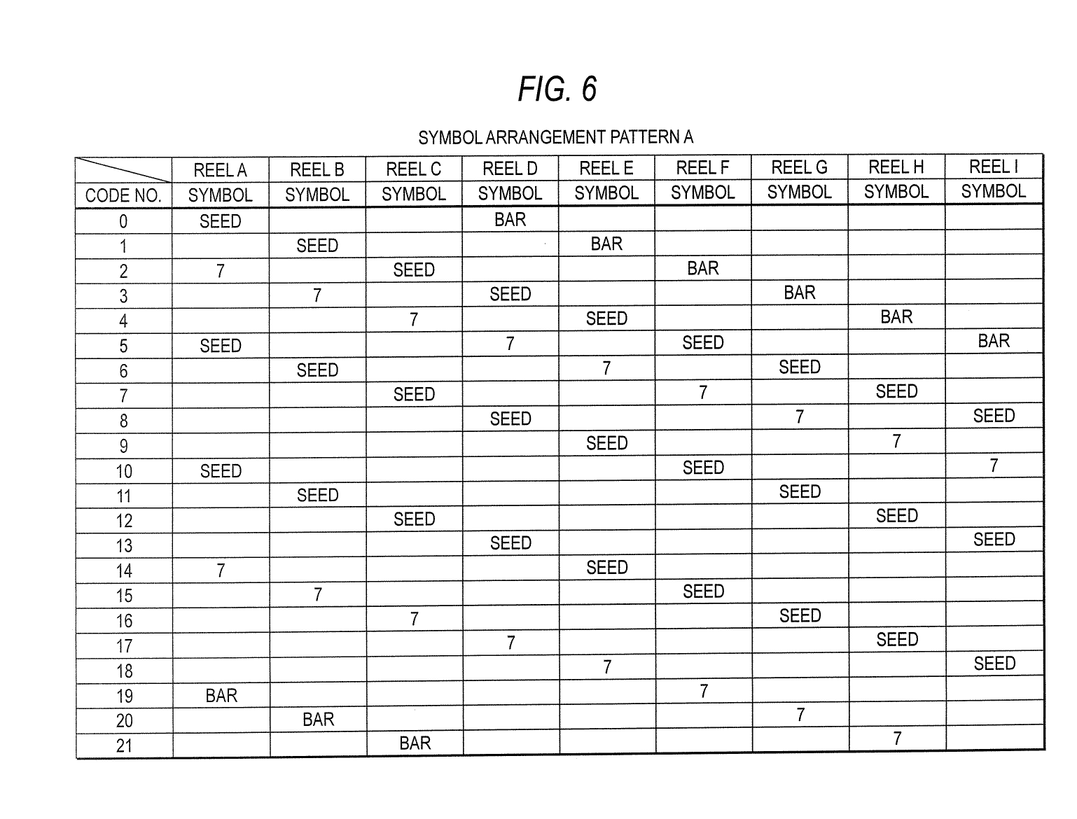

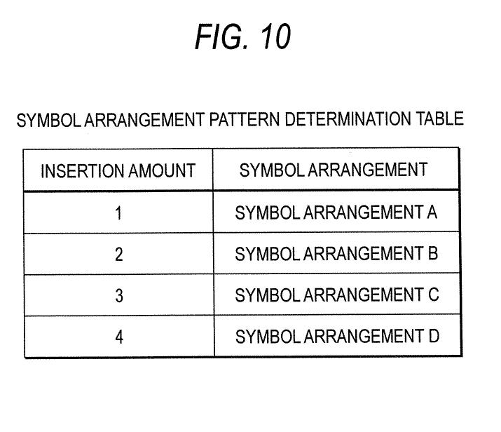

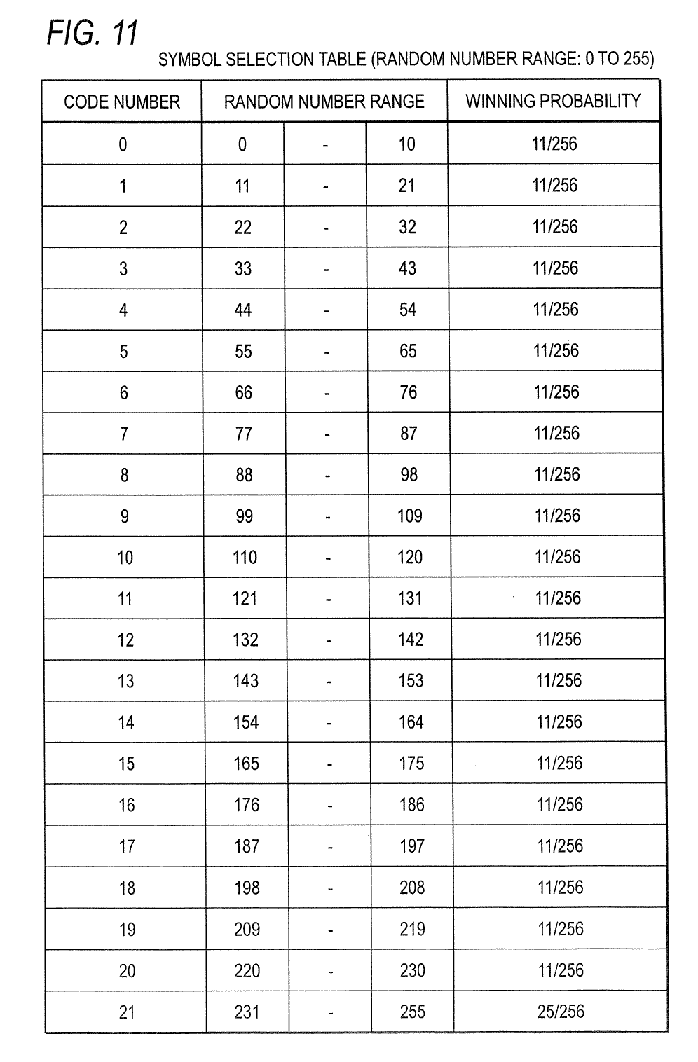

The ROM 34 stores various kinds of program for performing processes necessary for an implementation of the game, such as a main process, a medal insertion process, a reel control process, a selection process and a free game process, all to be described hereafter, and, during the implementation of the game, various kinds of data table such as a plurality of symbol arrangement pattern tables for the rotating reels displayed in the variable display portions 22A-22C, 23A-23C and 24A-24C (refer to FIGS. 6 to 9), a symbol arrangement pattern determination table which determines a symbol arrangement pattern (refer to FIG. 10), and a selection table for selecting a stopped display symbol of the game (refer to FIG. 11). The ROM 34 serves as symbol arrangement storage unit for storing a plurality of symbol arrangement patterns A to D shown in FIGS. 6-9.

The RAM 33 is a memory that serves as a storage unit that temporarily stores various kinds of data on which a calculation process has been performed in the main CPU 32, when the main CPU 32 operates in accordance with an operation program of the ROM 34, data and programs used are stored in the RAM 33. The RAM 33 includes a counter function, for example, a counter function which counts a quantity of game media paid out, a quantity of bets, a quantity of games and the like. In the embodiment, based on a count value of the quantity of bets, as will be described hereafter, the main CPU 32 selects a symbol arrangement pattern of the rotating reels stored in the RAM 34, and performs a drive reel control relating to a drive signal and a stop signal of each rotating reel, and a control relating to a grant of the game medium.

The programs, data and the like used when controlling the slot machine 1 not being limited to a case in which they are stored in advance in the ROM 34 or RAM 33, it is possible to change as appropriate, such as by storing in storage unit provided on a separate substrate. For example, it is also acceptable to have a configuration in which similar programs, data and the like are stored in a storage medium such as a compact flash®, and downloaded from this kind of storage medium onto the ROM 34 or the like, and it is also acceptable that an aspect is such that an authentication process or the like is performed with a host computer, and that kind of program or the like is downloaded.

A clock pulse generator 37, which generates a standard clock pulse, and a frequency divider 38 are connected to the main CPU 32. A random number generator 35 and a sampling circuit 36, which serves as a selection processing unit, are also connected to the CPU 32. The random number generator 35 operates in accordance with an instruction from the main CPU 32, and generates random numbers in a certain range. The sampling circuit 36, in accordance with an instruction from the main CPU 32, extracts an optional random number from among the random numbers generated by the random number generator 35, and inputs the extracted random number into the main CPU 32. The clock pulse generator 37 generates the standard clock pulse for operating the main CPU 32, and the frequency divider 38 inputs a signal in which the standard clock pulse is divided by a certain frequency into the main CPU 32. The random number sampled via the sampling circuit 36 is used in various kinds of selection of the winning combination and the like.

The main CPU 32, operating in accordance with the programs stored in the ROM 34, receives a signal, via an I/O port 39, from the medal insertion slot 6 (the inserted medal sensor 6a), the bill insertion slot 7 (the inserted bill insertion slot 7a), the spin button 8 (the spin switch 8a), the 1 BET button 9 (the 1 BET switch 9a), or the maximum BET button 10 (the maximum BET switch 10a) provided in the pedestal portion 11 and, based on the signal, performs an overall operation control accompanying the implementation of the game.

A lamp drive circuit 59, an LED drive circuit 61, a hopper drive circuit 63, and a payout completion signal circuit 65 are connected, via the I/O port 39, to the main CPU 32. An image control circuit 71, which controls to an image to be displayed on the main display 3 and the subsidiary display 4, and a sound control circuit 72, which performs a control of a sound emitted from the speakers 12L and 12R, are connected, via the I/O port 39, to the main CPU 32.

The lamp drive circuit 59 performs the effect of the game by transmitting a signal for illuminating various kinds of lamp 60 to the lamps 60, for example, causing the lamps 60 to flash during an execution of the game. The LED drive circuit 61 controls a flashing display of an LED 62 which performs a display of information necessary for the implementation of the game such as, for example, a credit quantity display or an acquired quantity display. The lamps 60 and the LED 62, although not shown in FIG. 1, are installed in a portion easily visible to the player.

The hopper drive circuit 63 drives the hopper 64 in accordance with a control of the main CPU 32, and the hopper 64, performing an operation for performing a payout of the medal, pays the medal out into the medal payout opening 13. A medal detector 66 counts a quantity of coins paid out by the hopper 64, and notifies the payout completion signal circuit 65 of data of the counted quantity value. The payout completion signal circuit 65 receives the data of the medal quantity value from the medal detector 66 and, in the event that the quantity value reaches data of a set quantity value, transmits a signal informing of a medal payout completion to the main CPU 32.

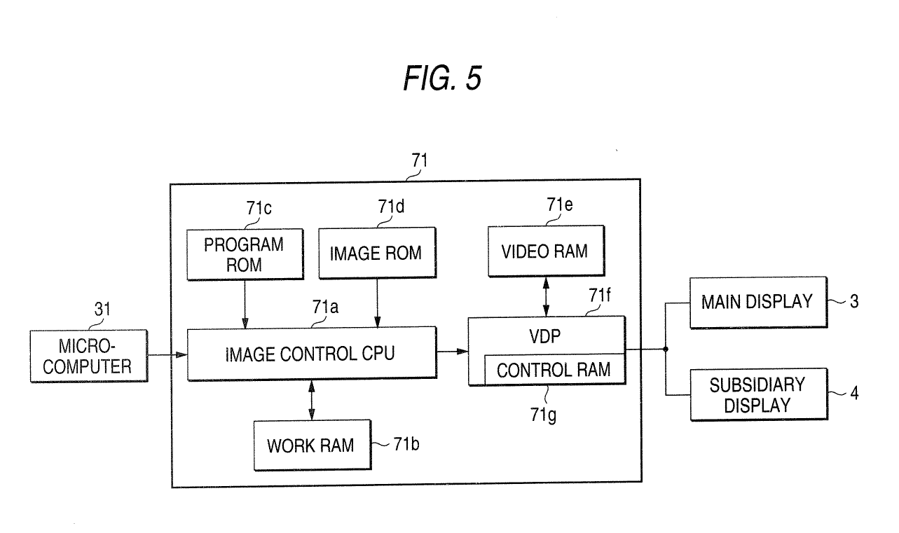

The image control circuit 71, which serves as a symbol variation unit, controls an image display on each of the main display 3 and the subsidiary display 4, and causes various kinds of image, such as a scrolling symbol image, to be displayed on the main display 3 and the subsidiary display 4. The image control circuit 71, as shown in FIG. 5, has an image control CPU 71a, a work RAM 71b, a program ROM 71c, an image ROM 71d, a video RAM 71e and a VDP (Video Display Processor) 71f.

The image control CPU 71a, based on parameters set by the microcomputer 31 and in accordance with an image control program stored in advance in the program ROM 71c, determines an image (a symbol image or the like) to be displayed on the main display 3 and the subsidiary display 4. The work RAM 71b is configured as temporary storage unit for when the image control CPU 71a executes the image control program. The program ROM 71c stores the image control program, the various kinds of selection table and the like. The image ROM 71d stores dot data (bitmap data) for forming the image. Data of the various kinds of symbol image are included in the dot data.

The video RAM 71e is configured as temporary storage unit for when the VDP 71f forms the image. In this case, the VDP 71f, having a control RAM 71g, forms images corresponding to display details of the main display 3 and the subsidiary display 4 determined by the image control CPU 71a, and transmits the images formed to the main display 3 and the subsidiary display 4.

The sound control circuit 72 transmits a sound signal for outputting the sound from the speakers 12L and 12R to the speakers 12L and 12R. The sound is emitted from the speakers 12L and 12R in order to enliven the game at an appropriate point, for example, after a start of the game.

Next, a description will be given of the symbols used in the game of the slot machine 1.

The reel A to the reel I, configured of twenty-two symbols (each symbol is allotted a code number from 0 to 21) arrayed in a prescribed order, being cyclically scroll displayed respectively in the variable display portions 22A-22C, 23A-23C and 24A-24C of the main display 3, as shown in the symbol arrangement pattern A (the case in which the quantity of bets is one) of FIG. 6, it appears to the player exactly as though the mechanical reels were rotating, and the symbols were changing.

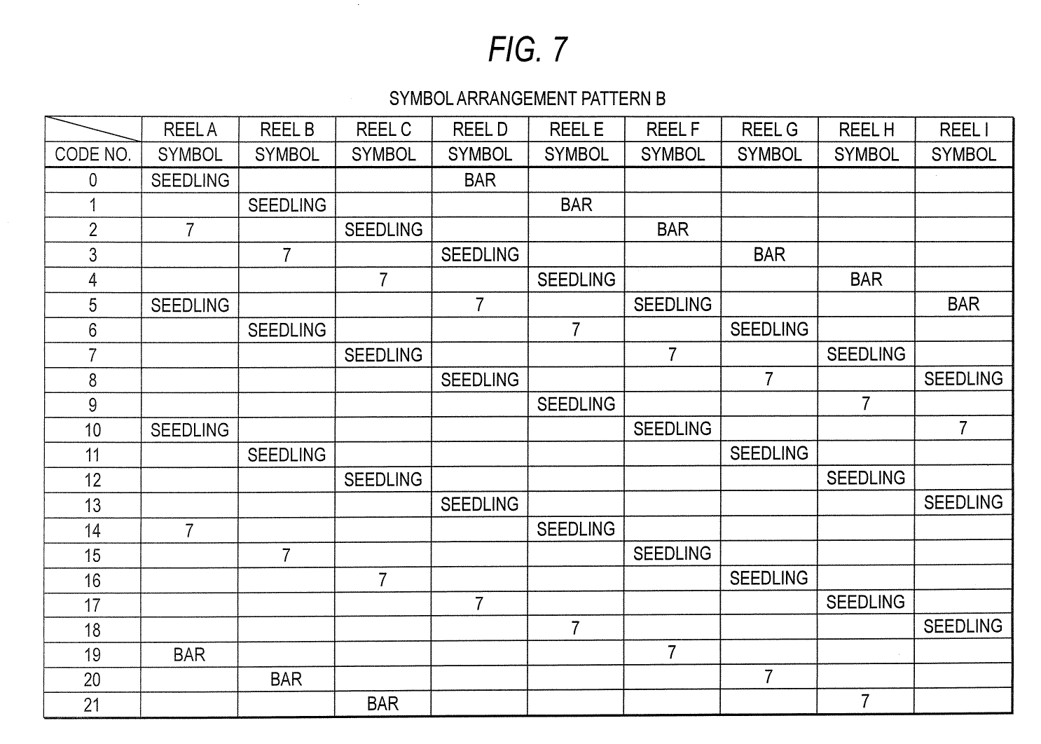

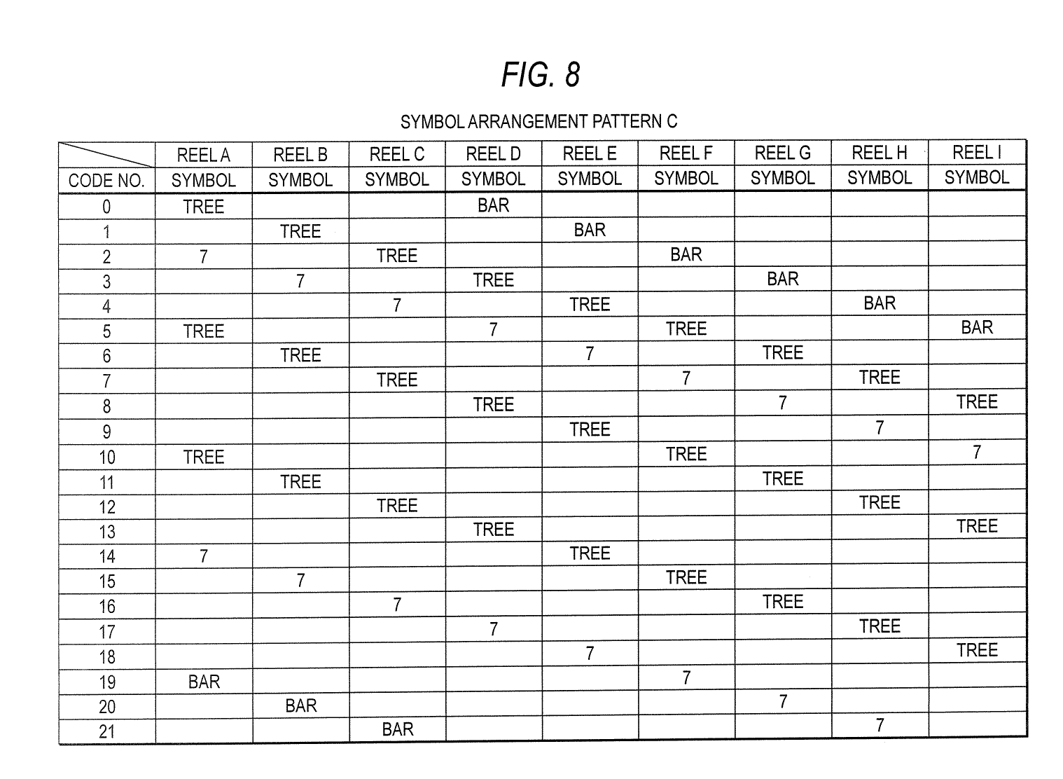

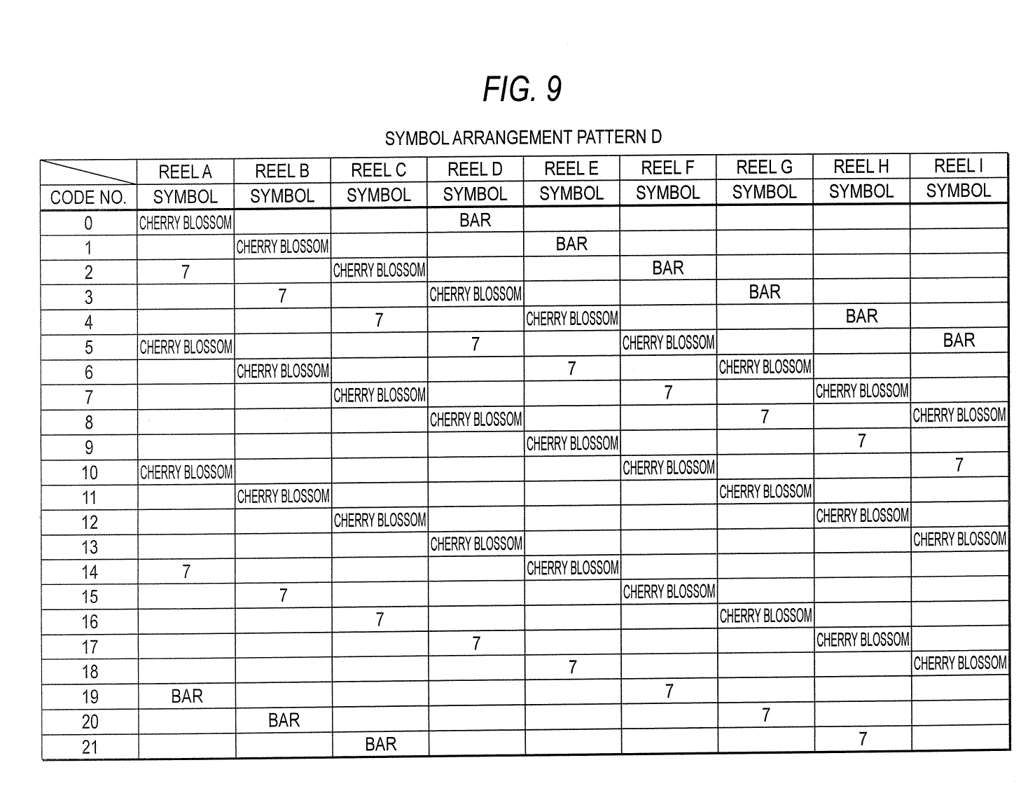

The symbol arrangement pattern A shown in FIG. 6 is configured of four kinds of symbol, a “seed” symbol, a “7” symbol, a “BAR” symbol and a “blank” symbol, as symbols configuring a symbol array. Of these, the blank symbol, being unconnected with a winning, is a symbol corresponding to a so-called losing. Also, the symbol arrangement pattern B shown in FIG. 7 is configured of four kinds of symbol, a “seedling” symbol, the “7” symbol, the “BAR” symbol and the “blank” symbol, as symbols configuring a symbol array. Also, the symbol arrangement pattern C shown in FIG. 8 is configured of four kinds of symbol, a “tree” symbol, the “7” symbol, the “BAR” symbol and the “blank” symbol, as symbols configuring a symbol array. Then, the symbol arrangement pattern D shown in FIG. 9 is configured of four kinds of symbol, a “cherry blossom” symbol, the “7” symbol, the “BAR” symbol and the “blank” symbol, as symbols configuring a symbol array.

The symbol arrangement patterns displayed in the variable display portions 22A-22C, 23A-23C and 24A-24C are determined, in accordance with the symbol arrangement pattern determination table shown in FIG. 10 configuring symbol arrangement determination means, depending on the quantity of medals which the player inserts (a size of a gaming value). That is, in the embodiment, in the event that one medal is inserted (BET), the symbol arrangement pattern A is selected, in the event that two medals are inserted (BET), the symbol arrangement pattern B is selected, in the event that three medals are inserted (BET), the symbol arrangement pattern C is selected, and in the event that four medals, which is a maximum quantity, are inserted (BET), the symbol arrangement pattern D is selected.

In the heretofore described symbol arrangement patterns A-D, a specified symbol changes in an order of “the seed->the seedling->the tree->the cherry blossom”, in accordance with an increase in an insertion amount of the medal (or a number of bet medals), providing the changing specified symbol with a relevancy to have a story aspect. In each of the symbol arrangement patterns B-D may also change, in the same way as in the symbol arrangement pattern A, a code number from 0 to 21 is allotted to each symbol corresponding to the reel A to the reel I.

The specified symbol may be configured to change with a relevancy to have a sense of differing values in accordance with the increase in an insertion amount of the medal (or a number of bet medals) as such as “cherry->bell->7->special character”.

In the event that one of the heretofore described symbol arrangement patterns has been selected, the symbols stop displayed in the variable display portions 22A-22C, 23A-23C and 24A-24C are determined by, for example, symbol determination means such as described hereafter.

The heretofore described main CPU 32, on detecting the start operation of the player (for example, the operation of the spin switch 8), in response to the detection (that is, taking the game start as an impetus), instructs the random number generator 35 to generate the random numbers in the certain range. Also, the main CPU 32 instructs the sampling circuit 36 to extract the optional random number from among the random numbers generated by the random number generator 35. The main CPU 32, on the random number being extracted, sets the random number in a search key, and refers to a symbol selection table stored in the ROM 34 (refer to FIG. 11), whereby the code number is acquired.

Next, the main CPU 32 sets the acquired code number in the search key and, referring to the symbol arrangement pattern table ordered by reel, searches for a stopped symbol to be stop displayed in the variable display portion. For example, in the case in which the symbol arrangement pattern A is selected, regarding the reel A in the variable display portion 22A, in the event that the code number 5 is determined by the random number value extracted in the symbol selection table shown in FIG. 11, the “seed” symbol is determined from the symbol arrangement pattern A shown in FIG. 6.

The heretofore described kind of random number extraction, symbol selection table search and symbol arrangement table search are performed a total of nine times, once for each of the variable display portions 22A-22C, 23A-23C and 24A-24C. That is, by performing the table searches a quantity of times corresponding to a quantity of the variable display portions, the stopped symbols in the variable display portions 22A-22C, 23A-23C and 24A-24C are determined.

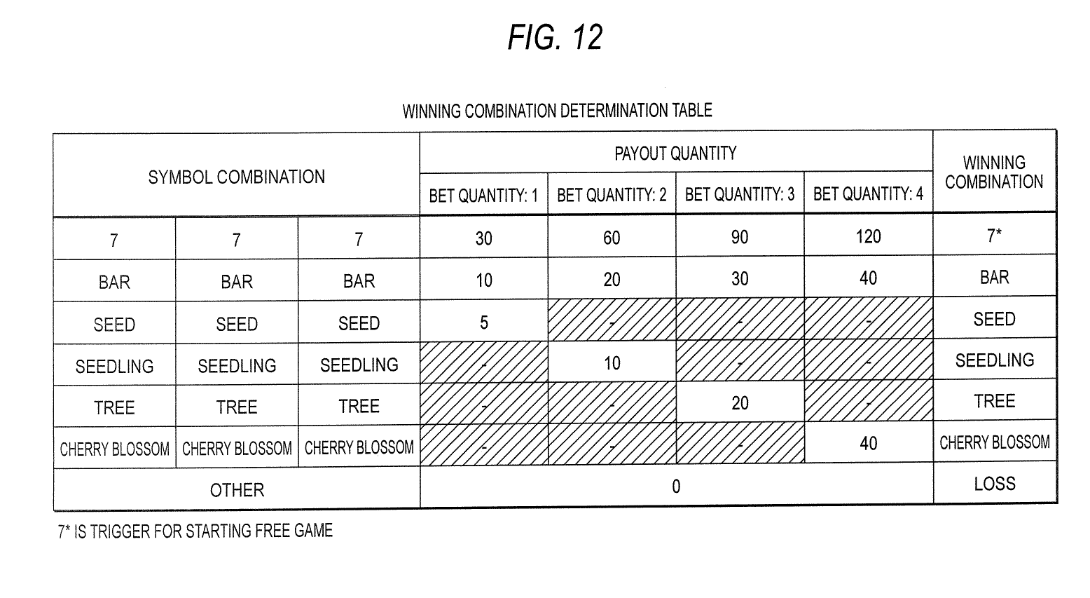

On the stopped symbol being determined for each of the variable display portions by means of the heretofore described procedure, as well as the stopped symbol of each reel being stored, an established winning combination is stored, for each activated pay line shown in FIG. 3, in the RAM 33. Then, the main CPU 32, based on the determined stopped symbol of each reel and referring to a winning combination determination table shown in FIG. 12, determines the winning combination.

According to the winning combination determination table shown in FIG. 12, although, with regard to the symbols other than the changing specified symbol (the “7” and the “BAR”), a payout quantity also increases by two times, three times or four times in accordance with the bet quantity being two, three or four, in the case of the changing specified symbol, on a winning combination thereof being established, the payout quantity is changed in such a way as to be two times, four times or eight times. That is, in the event that the changing specified symbol wins, a setting is such that an award change becomes larger as an extent of growth becomes greater (of course, it is possible to change this kind of award amount as appropriate).

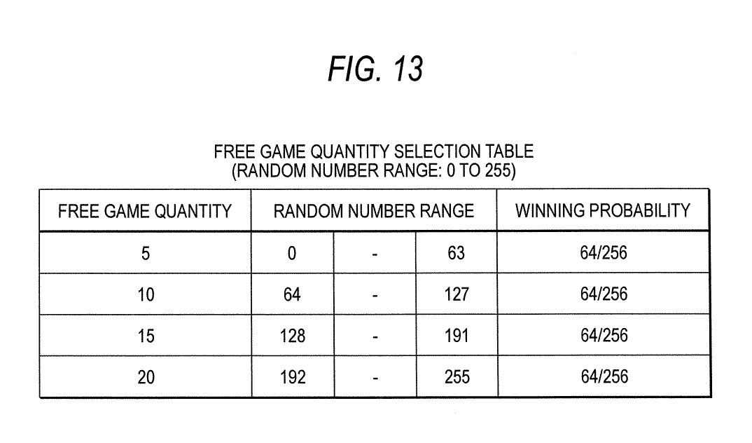

In the embodiment, as a combination of “7” symbols is a trigger for a transfer to the free game, by “7” being established as the winning combination, a relatively large profit is granted to the player. The free game being, for example, of a bonus game aspect in which the heretofore described game can be played a prescribed quantity of times without inserting the game medium, the player, during this time, can receive a payment of the medal without reducing the quantity of medals or credits, and has a great advantage as regards a medal acquisition. Regarding the quantity of free games which can be executed, when “7” is established as the winning combination, the selection process is executed, and the main CPU 32 determines the quantity of games based on a free game quantity selection table shown in FIG. 13.

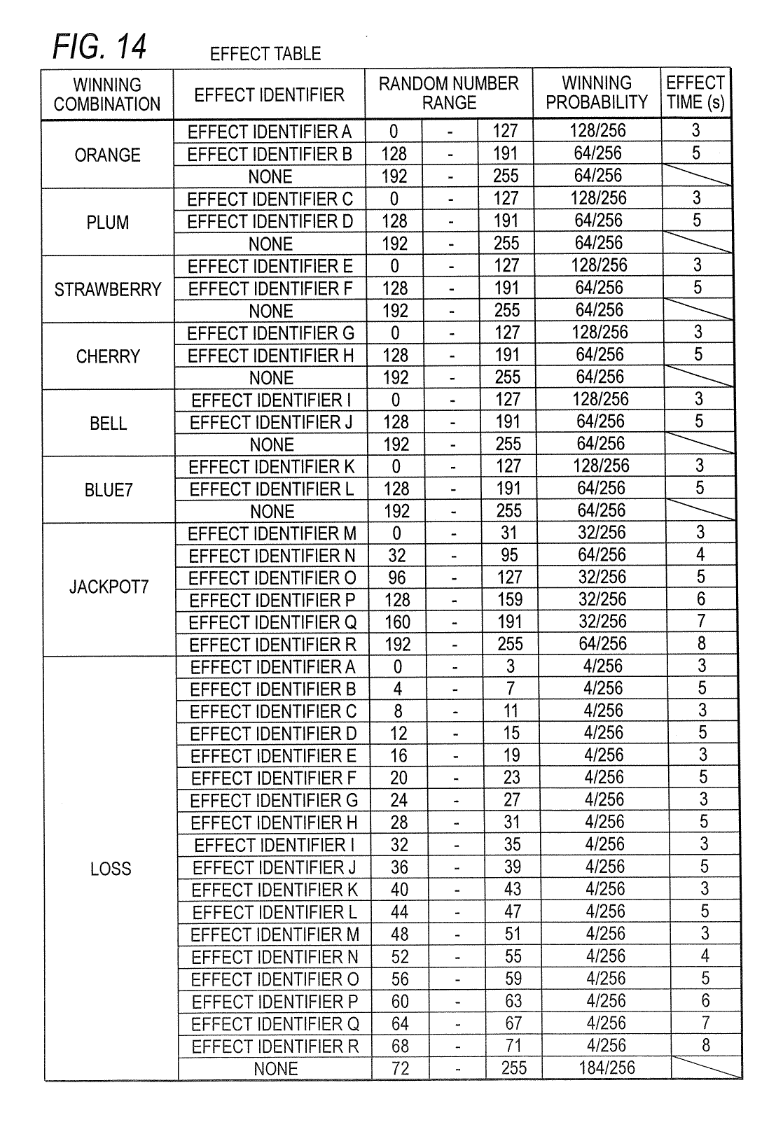

When the winning combination is determined in the heretofore described way, an effect corresponding to the winning combination is performed. The effect being determined in accordance with an effect table shown in FIG. 14 by the selection process, an effect image stored in advance correlated to an effect identifier determined by the selection is selected, and the selected effect image is displayed for a prescribed time on the main display 3 or the subsidiary display 4. In addition to the effect by the image, it is also acceptable to carry out an effect related to the sound by means of the speakers 12L and 12R.

Hereafter, a description will be given, while referring to flowcharts, of a control method which controls the implementation of the game in the slot machine 1 according to the embodiment. In the flowcharts shown hereafter, a step will be abbreviated to “S”. Also, the following processes are performed by the main CPU 32 executing information related to a slot game of the programs stored in the ROM 34 and the RAM 33.

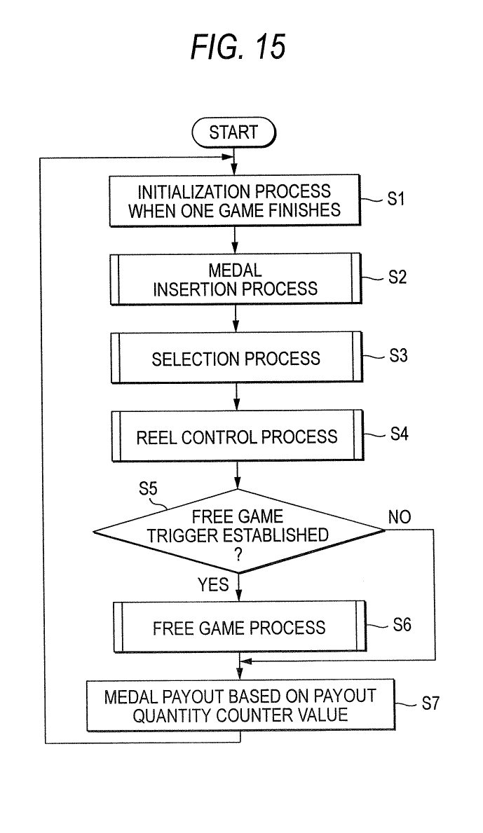

FIG. 15 is a flowchart showing an example of the main process in the slot machine 1.

When the main process is started, the slot machine 1 (more specifically, the main CPU 32) executes a one game finishing time initialization process (S1). This process is a process which, for example, in an initialization condition in which a power switch of the slot machine 1 has been put in an on condition, being a process in which the main CPU 32 initializes prescribed data (the data stored in the RAM 33, communication data etc.), in a condition in which the game is being played, performs a deletion of parameters stored in the RAM 33 at a previous game finishing time, a writing process of parameters to be used in a next game, a specification of a start address of a sequence program, and the like.

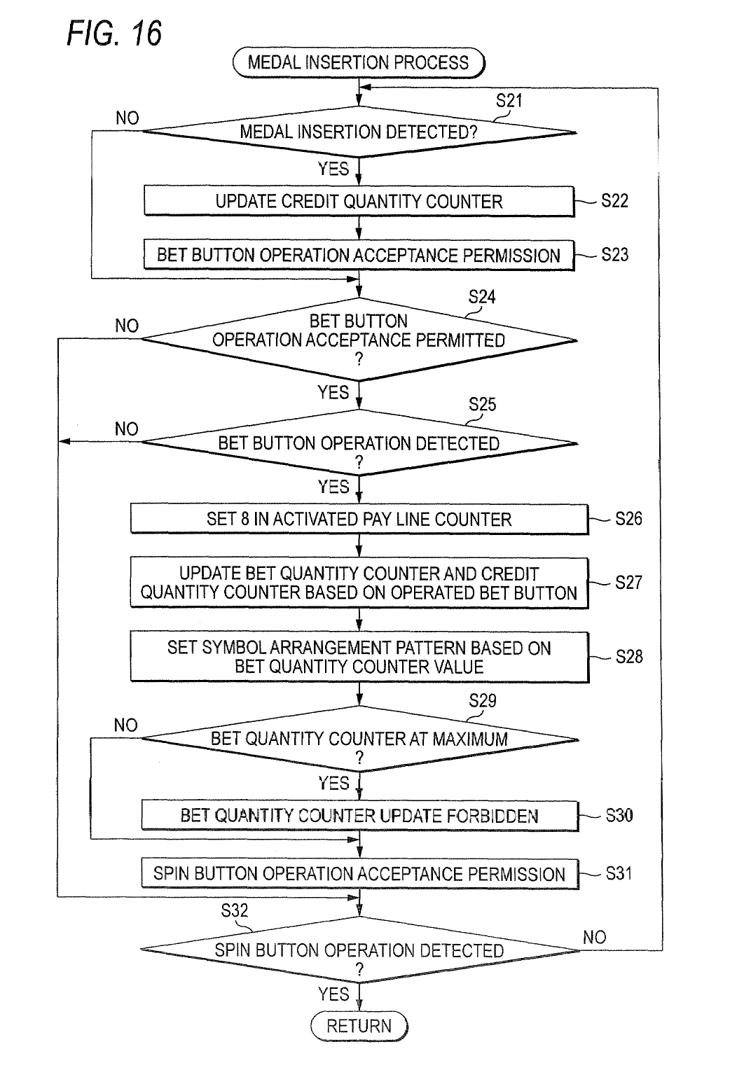

Next, the main CPU 32 performs the medal insertion process (S2). A description of the medal insertion process will be given with reference to a flowchart shown in FIG. 16.

First, it is determined whether or not the insertion of the medal has been detected by the inserted medal sensor installed in the medal insertion slot 6 (S21). If the insertion of the medal has been detected, an update of a credit quantity counter is performed (S22), and an acceptance of a BET button operation is permitted (S23). If the BET button operation is detected in a condition in which the acceptance of the BET button operation has been permitted, 8 is set in an activated pay line counter (S24: Yes, S25: Yes, S26). The activated pay lines here corresponding to the activated pay lines L1 to L8 shown in FIG. 3, all the lines L1-L8 are activated by the BET operation.

Even if the medal is not inserted in S21, if a prescribed quantity of medals is in an accredited condition, the BET button operation is accepted regardless (S21: No, S24 to S26).

An update process of a BET quantity counter and the credit quantity counter being performed based on the BET button operated (S27), one of the symbol arrangement patterns A to D shown in FIGS. 6-9 is selected and set based on a value of the BET quantity counter (S28). Herein, when the bet quantity is one, the symbol arrangement pattern A is selected, when the bet quantity is two, the symbol arrangement pattern B is selected, when the bet quantity is three, the symbol arrangement pattern C is selected, and when the bet quantity is four, the symbol arrangement pattern D is selected. In the event that, by the BET operation of the player, the BET quantity counter has reached a maximum value, the update of the BET quantity counter is forbidden (S29: Yes, S30), and a permitting of a spin button operation acceptance is performed (S31). In S29, if the BET quantity counter has not reached the maximum, the permitting of the spin button operation acceptance is performed immediately (S29: No, S31).

The player operates the spin button 8 and, when the operation is detected by the spin switch 8a (S32), the medal insertion process finishes, and the main CPU 32 moves to the selection process of the main flowchart shown in FIG. 16 (S4). If the player does not operate the spin button 8 in S32, the process of S21 to S32 is repeated.

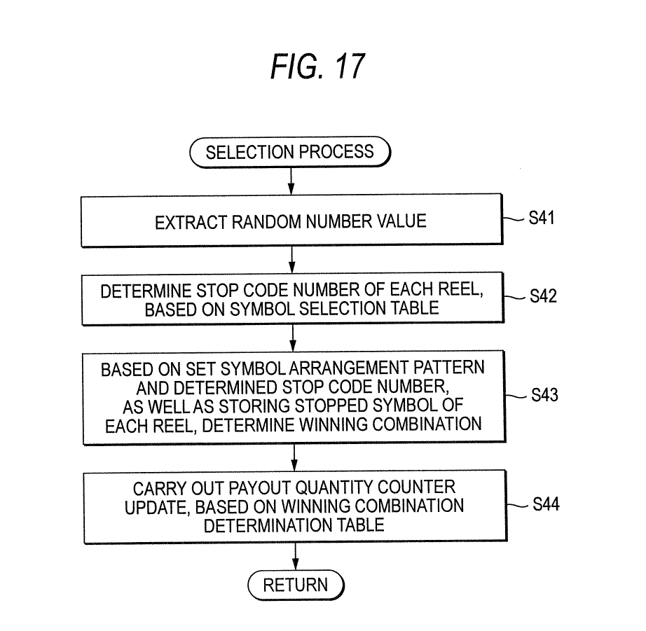

Continuing on from the medal insertion process of S2, the main CPU 32 moves to the selection process (S3). A description will be given of the selection process, with reference to a flowchart shown in FIG. 17.

The selection process being performed as a result of the signal from the spin switch 8a being received, the main CPU 32 extracts the random number value via the random number sampling circuit 36 (S41). Next, a stop code number of each reel is determined from the extracted random number value, based on the symbol selection table prepared in advance (refer to FIG. 11) (S42). At this time, the determination of the stop code number being performed a total of nine times, once for each of the variable display portions 22A-22C, 23A-23C and 24A-24C, as well as the symbols to be stopped in the reels being stored, the activated pay lines are searched in sequence, and the winning combination is determined, based on the symbol arrangement pattern set in S28 and the stop code number (S43).

Based on the symbols to be stopped determined in S43 and referring to the winning combination determination table (FIG. 13), the payout quantity is specified, an update of a payout quantity counter is performed (S44), and the selection process finishes.

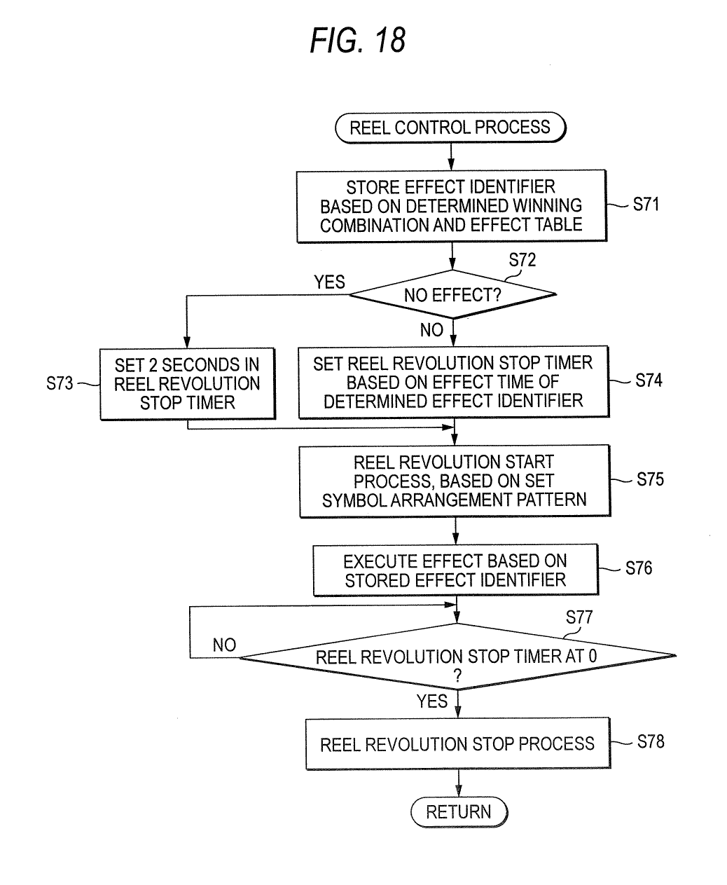

Continuing on from the selection process of S3, the main CPU 32 moves to the reel control process (S4). A description will be given of the reel control process, with reference to a flowchart shown in FIG. 18.

First, the main CPU 32 specifies an effect identifier based on the determined winning combination and on the effect table shown in FIG. 14, and stores it in the RAM 33 (S71). In this case, if there is no effect identifier (if the effect is not performed), the main CPU 32 sets two seconds in a reel revolution stop timer and, based on the set symbol arrangement pattern (one of the symbol arrangement patterns A to D), executes a reel revolution process (S72: Yes, S73 and S75). Then, after the two seconds have elapsed, a reel revolution stop process is executed, causing the symbols determined by the selection to stop in such a way as to be displayed in the reels (S77 and S78).

Meanwhile, if there is an effect identifier, the main CPU 32 sets an effect time specified in the effect table shown in FIG. 14 in the reel revolution stop timer and, based on the set symbol arrangement, executes the reel revolution process (S72: No, S74 and S75). In this case, the effect image correlated to the effect identifier and stored in advance is selected, the selected effect image is displayed for a corresponding time on the main display 3 or the subsidiary display 4, and the reel revolution stop process is executed (S76 to S78).

In the reel control process, as a probability of the effect fixed in advance corresponding to the winning combination, as in the effect table shown in FIG. 14, being performed is high, as well as the player, depending on the effect performed when the reel is revolution driven, being able to predict a certain level of the winning combination, as a case of not winning even though that kind of effect is performed (a so-called bogus effect), or a case of winning even though the effect is not performed, can occur, a heightening of interest is achieved.

Continuing on from the reel control process of S4, it is determined whether or not a free game trigger is established (S5) and, if the free game is not established, a medal payout process is executed immediately based on the value of the payout quantity counter specified in S44 in the selection process (S7).

When this process is finished, the main CPU 32 returns the process to step S1 in order to execute the game process for a next round of the game.

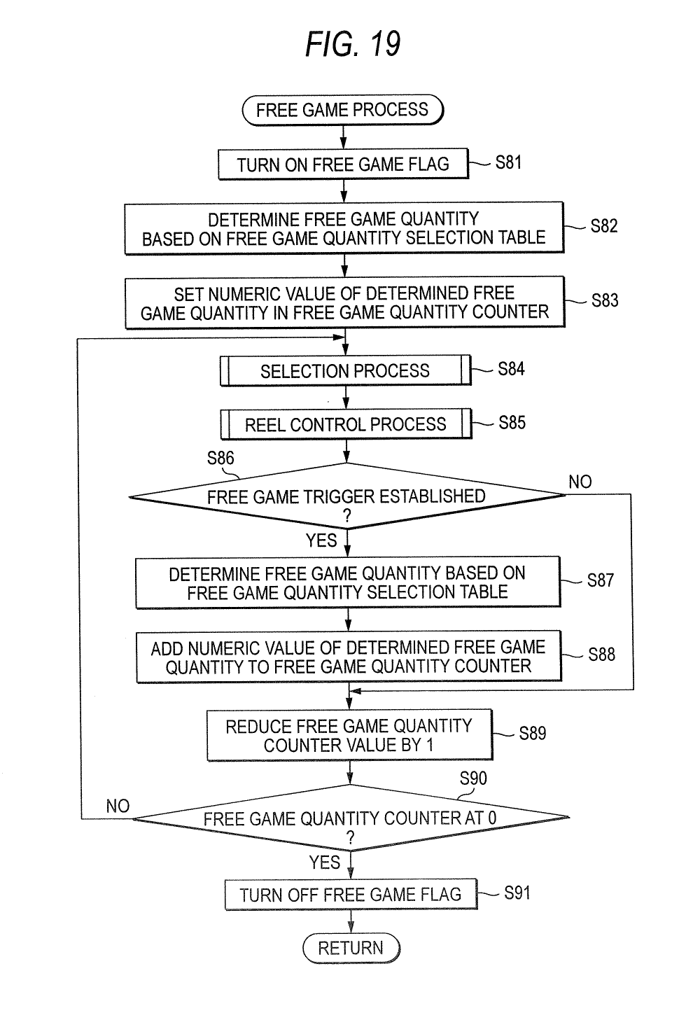

In the process of S5, if the free game trigger is established, the free game process is executed. The free game, as described heretofore, being established when the “7” symbols come together as the winning combination on any one of the activated pay lines, this kind of free game is a right whereby the player can play the game the prescribed quantity of times, without inserting the medal. Hereafter, a procedure of the free game process will be described in accordance with a flowchart shown in FIG. 19.

When executing the free game process, the main CPU 32 turns on a free game flag and, by means of the selection process, determines the quantity of free games based on the free game quantity selection table (refer to FIG. 13) (S81 and S82). A numeric value of the quantity of free games determined by the selection process is set in the free game quantity counter of the RAM 33 (S83).

Next, the selection process and the reel control process are executed in accordance with a game operation of the player (S84 and S85). These processes are performed in accordance with the heretofore described flowcharts shown in FIGS. 17 and 18 respectively.

After the reel control process of S85 (S71 to S78) is finished, it is determined whether or not the free game trigger is established (S86). That is, if, during the free game presently being executed, the winning combination is again established by the “7” symbols being aligned on any one of the activated pay lines, during the heretofore described process procedures of S84 and S85 (S86: Yes), the free game trigger is established, the quantity of free games is determined, by means of the selection process, based on the free game quantity selection table (refer to FIG. 13) (S87), and the quantity of free games determined is added to the free game quantity counter (S88). That is, it means that, even during a playing of the free game, in a case in which the free game is established, a right thereof is added, and it is possible by this means for the player to obtain a greater profit.

Next, the main CPU 32 subtracts one from a value of the free game quantity counter (S89). This kind of free game is executed until the free game quantity counter reaches zero (the quantity of times obtained by the selection process) (S90: No, S84 to S90) and, at a point at which the free game quantity counter reaches zero, the free game flag is turned off (S90: Yes, S91).

Subsequently, moving to the process of S7, the main CPU 32 performs the payout process of the medals (the value stored in the payout quantity counter) obtained in the free game, and the free game is finished. That is, the medals obtained during the free game are paid out at one time at a point at which the free game is finished.

According to the slot machine including the heretofore described kind of game procedure, as the symbols variably displayed in the variable display portions change in accordance with the quantity of medals (BET quantity) inserted by the player, it is possible for the player, by visually confirming an arrangement pattern of the varying symbols, to immediately ascertain the BET quantity of the medals in the game currently being performed. That is, it being possible to immediately ascertain the BET quantity, for each BET operation, by visually confirming the arrangement pattern of the varying symbols, without memorizing the BET quantity, a burden of memorizing the BET quantity for each game is lightened.

In the embodiment, as the specified symbols which change by bet quantity are provided with the relevancy (the story aspect), as well as it being easy to ascertain the BET quantity, it is possible to achieve a heightening of interest.

Although the description has heretofore been given of the embodiment of the present invention, the present invention is not limited to the heretofore described embodiment and can be implemented in a variety of aspects, as described hereafter.

With regard to an aspect of the changing symbols in the heretofore described embodiment, and the changing stages, it is possible to make an appropriate modification. Also, it is also acceptable that, on the medal being inserted, a change is made to a prescribed symbol (in the embodiment, one of the seed, the seedling, the tree or the cherry blossom) by means of the selection process. Also, it also being possible to make an appropriate modification with regard to the award amount of the game medium, it is also acceptable to, for example, have a display such as “×2”, “×3” on the symbol, in order to make the award more easily understandable.

Also, with regard to the changing symbol arrangement patterns, although it has been the four symbols the “blank”, the “7”, the “BAR” and the changing symbol, it is also possible to make an appropriate modification with regard to the kinds of symbol and the arrangement patterns.

Furthermore, in the heretofore described embodiment, the slot machine having nine variable display portions has been exemplified as the gaming machine, but it is also acceptable that it is a so-called three reel slot machine or five reel slot machine, having three or five variable display portions, while it is also acceptable that variable display means is configured of mechanical reels. The present invention can also be applied to a gaming machine other than the slot machine, such as, for example, a card game machine or a pachinko machine.

What is claimed is:

1. A gaming machine comprising:
a display unit that variably displays a plurality of symbols in each of a plurality of variable display portions;
an operation unit that allows a player to input commands;
a storage unit that stores a plurality of symbol arrangement patterns, each of which defines an order of the symbols to be variably displayed;
an insertion slot that allows the player to insert game medium to be bet on a game; and
a processor that operates to:
select one from the symbol arrangement patterns based on a size of a value of the game medium bet on the game;
control the display unit to variably display the symbols for a predetermined time period in each of the variable display portions in accordance with the selected symbol arrangement pattern when a start command is input through the operation unit to start the game; and
pay out an award to the player in accordance with a combination of the symbols displayed stopped in the variable display portions.

2. The gaming machine according to claim 1, wherein the display unit is provided with an image display device that displays an image of a video reel in each of the variable display portions.

3. The gaming machine according to claim 1 further comprising a payout unit that pays out a predetermined amount of game medium in accordance with the award paid out to the player.

4. The gaming machine according to claim 1, wherein each of the symbol arrangement patterns has a relevancy with one another, the relevancy being related to the size of the value of the game medium bet on the game.

5. A gaming machine comprising:
a display unit that variably displays a plurality of symbols in each of a plurality of variable display portions;
an operation unit that allows a player to input commands;
a storage unit that stores a symbol arrangement pattern that defines an order of the symbols to be variably displayed;
an insertion slot that allows the player to insert game medium to be bet on a game; and
a processor that operates to:
change a specified symbol included in the symbols defined by the symbol arrangement pattern based on a size of a value of the game medium bet on the game;
control the display unit to variably display the symbols for a predetermined time period in each of the variable display portions in accordance with the symbol arrangement pattern when a start command is input through the operation unit to start the game; and
pay out an award to the player in accordance with a combination of the symbols displayed stopped in the variable display portions.

6. The gaming machine according to claim 5, wherein the display unit is provided with an image display device that displays an image of a video reel in each of the variable display portions.

7. The gaming machine according to claim 5 further comprising a payout unit that pays out a predetermined amount of game medium in accordance with the award paid out to the player.

8. The gaming machine according to claim 5, wherein each of the symbol arrangement patterns has a relevancy with one another, the relevancy being related to the size of the value of the game medium bet on the game.
